(19) United States
(12) Patent Application Publication
(10) Pub. No.: US 2015/0200031 A1
(43) Pub. Date: Jul. 16, 2015

(54) METHOD OF FABRICATING NANOWIRE AND GRAPHENE-SHEET HYBRID STRUCTURE AND TRANSPARENT ELECTRODE USING THE SAME

(71) Applicant: Electronics and Telecommunications Research Institute, Daejeon (KR)

(72) Inventors: Doo Hyeb YOUN, Daejeon (KR); Choon Gi CHOI, Daejeon (KR); Jin Soo KIM, Namyangju-si (KR); Young Jun YU, Daejeon (KR); Jin Sik CHOI, Daejeon (KR); Hong Kyw CHOI, Daejeon (KR)

(73) Assignee: Electronics and Telecommunications Research Institute, Daejeon (KR)

(21) Appl. No.: 14/333,002

(22) Filed: Jul. 16, 2014

(30) Foreign Application Priority Data
Jan. 15, 2014 (KR) 10-2014-0005154

(51) Int. Cl. H01B 1/02; C23C 28/00; C23C 4/00; C23C 4/12; C23C 4/18

(52) U.S. Cl. CPC H01B 1/02; C23C 4/12; C23C 4/18; C23C 4/005; C23C 28/00

(57) ABSTRACT

The present invention relates to a method of fabricating a nanowire and graphene-sheet hybrid structure, and a transparent electrode employing the same, in which a hybrid structure, in which a graphene sheet is attached on surfaces of nanowires, is fabricated by fabricating a line pattern, in which nanowires are aligned in a longitudinal direction, by using an electro-spinning method, and then additionally employing a dipping method of dipping the line pattern in a graphene sheet dispersed solution, and the fabricated hybrid structure is applied to the transparent electrode. Accordingly, a crosslinking portion is increased by decreasing a distance between nanowires present inside the line pattern to improve a conductive property of a nanowire metal line. Further, the nanowire with a relative uniform density is present within the fabricated line pattern, so that when the line pattern is fabricated on the entire substrate, it is possible to achieve a uniform distribution of nanowires over a large area. Further, the surfaces of the nanowires are covered by the graphene sheet by adopting the dipping process of dipping the nanowire line pattern in a dispersion solution in which the graphene sheet is evenly dispersed, thereby preventing oxidation of the nanowire due to a contact with air during a thermal treatment process.

### CROSS-REFERENCE TO RELATED APPLICATIONS

This application is based on and claims priority from Korean Patent Application No. 10-2014-0005154, filed on Jan. 15, 2014, with the Korean Intellectual Property Office, the disclosure of which is incorporated herein in its entirety by reference.

### BACKGROUND

1. Field

The present invention relates to a method of fabricating a hybrid structure in which a graphene sheet is attached to a surface of a nanowire, and a transparent electrode using the same, and more particularly, to a hybrid structure in which a graphene sheet is attached to a surface of a nanowire, by fabricating a line pattern, in which nanowires are aligned in a longitudinal direction, by using an electro-spinning method, and then additionally adopting a dipping method of dipping the line pattern into a solution in which the graphene sheet is dispersed, and a transparent electrode using the same.

2. Discussion of Related Art

A nanowire formed of a metal component has an excellent conductive property and is thin to have several nm, and thus has a transparent property in a visible light region, so that the nanowire is widely used as a material of a transparent electrode. In a case where a transparent electrode is fabricated by using the nanowire, a method of spin-coating a solution, in which a silver nanowire is dispersed, on a substrate is generally used.

FIG. 1 is an electron-microscope picture showing a distribution of nanowires coated on a substrate by using the spin-coating method. As illustrated in FIG. 1, a region (white portion), in which the nanowires are present, and a region, in which the nanowires do not present, are non-uniformly distributed, so that a portion, in which the nanowires fail to cross each other, is generated, thereby degrading a conductive property. As the number of rotations is increased during the spin-coating, an agglomeration phenomenon of the nanowires becomes more severe.

Accordingly, a sheet resistance value of a surface of the nanowire is several tens to several hundreds of Ω/□, and has a relatively large value to be used as a transparent electrode. In this case, when a coating thickness of the nanowire is increased to be several tens of μm an or more in order to decrease the sheet resistance, there is a problem in that transmittance is decreased to be 70% or lower. In general, the transparent electrode is demanded to have a sheet resistance value of 30 Ω/□ or lower at transmittance of 80% or more.

Further, an interfacial surface, on which the nanowires cross and meet each other, does not exhibit an ohmic property by contact resistance, so that a conductive property in the interfacial surface deteriorates. Accordingly, the interfacial surface is removed by melting a point, at which two nanowires meet, by performing thermal processing at a specific temperature. However, the surface of the nanowire is combined with oxygen in the air to cause oxidation of the nanowire during the thermal processing process, thereby degrading a conductive property.

### SUMMARY

In this respect, the present inventors studied a method of improving a conductive property by improving efficiency of crosslinking of nanowires, a method of uniformly distributing nanowires over a large area, and a method of preventing a conductive property from being degraded due to oxidation of the nanowire according to contact of the nanowire and oxygen in the air during thermal processing. As a result, the inventors completes the present invention capable of fabricating a hybrid structure, in which a graphene sheet is attached to surfaces of nanowires, by fabricating a line pattern, in which nanowires are aligned in a longitudinal direction, by using an electro-spinning method, and then additionally adopting a dipping method of dipping the line pattern into a solution in which the graphene sheet is dispersed, and capable of fabricating a transparent electrode including a mesh structure having an excellent electrical conductive property and transmittance efficiency.

The present invention has been made in an effort to provide a method of fabricating a nanowire and graphene-sheet hybrid structure, and a transparent electrode employing a nanowire and graphene-sheet hybrid structure.

An embodiment of the present invention provides a method of fabricating a nanowire and graphene-sheet hybrid structure, including: preparing a mixed solution of a nanowire material and a polymer material; forming a nanowire line pattern by spraying the mixed solution to a grounded substrate by an electro-spinning method; dipping the substrate, on which the nanowire line pattern is formed, in a graphene sheet dispersed solution; and performing a thermal treatment so as to remove an interfacial surface between the nanowire line patterns.

In the method of fabricating the nanowire and graphene-sheet hybrid structure according to the present invention, the nanowire material may be any one of metal based Ag, Cu, Au, Pt, Mo, W, Ni, and Cr, and the polymer material may include one or more selected from the group consisting of polyvinyl alcohol (PVA), polyurethane (PU), polyimide (PI), polyethylene oxide (PEO), polyvinyl pyrrolidine (PVP), polystyrene (PS), and polyacrylonitrile (PAN).

Further, a line width in the nanowire line pattern may be 10 to 90 μm, the performing of the thermal treatment may be performed at a temperature of 70 to 90° C. for 5 to 20 minutes, and the nanowire and graphene-sheet hybrid structure may have a mesh form.

Another embodiment of the present invention provides a transparent electrode employing the nanowire and graphene-sheet hybrid structure obtained by preparing a mixed solution of a nanowire material and a polymer material; forming a nanowire line pattern by spraying the mixed solution to a grounded substrate by an electro-spinning method; dipping the substrate, on which the nanowire line pattern is formed, in a graphene sheet dispersed solution; and performing a thermal treatment so as to remove an interfacial surface between the nanowire lines in the nanowire line pattern.

Another embodiment of the present invention provides a nanowire and graphene-sheet hybrid structure, comprising: a nanowire mesh pattern having a mesh shape; and a graphene-sheet formed on the nanowire mesh pattern, wherein the nanowire mesh pattern includes nanowire line patterns coupled to each other without forming an interfacial surface therebetween.

The effects of the present invention will be described below.

First, a distance between the nanowires aligned within the pattern is decreased by adjusting the line width in the nanowire line pattern to have several tens of μm or lower, which is very narrow, thereby improving efficiency of crosslinking between the nanowires and improving a conductive property.

Second, the graphene covers the surfaces of the nanowires to prevent a conductive property from deteriorating due to oxidation during the thermal treatment process.

Third, it is possible to uniformly distribute the nanowires over a large area.

Fourth, the line pattern including the nanowire and graphene-sheet hybrid structure is manufactured in a mesh form, thereby fabricating a transparent electrode having an improved conductive property and thermal reliability.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

The above and other features and advantages of the present invention will become more apparent to those of ordinary skill in the art by describing in detail embodiments thereof with reference to the attached drawings in which:

FIG. 1 is an electron-microscope picture showing a distribution of spin-coated nanowires in the related art;

FIG. 2 is a mimetic diagram illustrating a process of fabricating a line-shaped nanowire alignment pattern by using an electro-spinning method;

FIG. 3 is a mimetic diagram illustrating a process of forming a hybrid structure of nanowires and a graphene sheet by a dipping process;

FIG. 4 is a mimetic diagram illustrating a connection of two nanowires through a thermal processing process;

FIG. 5 is a diagram illustrating a configuration of general electro-spinning equipment;

FIG. 6 is a diagram illustrating a configuration of near-field electro-spinning equipment;

FIG. 7 is an electron-microscope picture illustrating a graphene sheet attached onto surfaces of nanowires fabricated according to an exemplary embodiment of the present invention;

FIG. 8 is a graph illustrating a change in electro-conductivity between a nanowire line pattern electrode and a nanowire and graphene-sheet hybrid structure electrode fabricated according to an exemplary embodiment of the present invention; and

FIG. 9 is a mimetic diagram illustrating a structure of a transparent electrode including a nanowire and graphene-sheet hybrid structure fabricated according to an exemplary embodiment of the present invention.

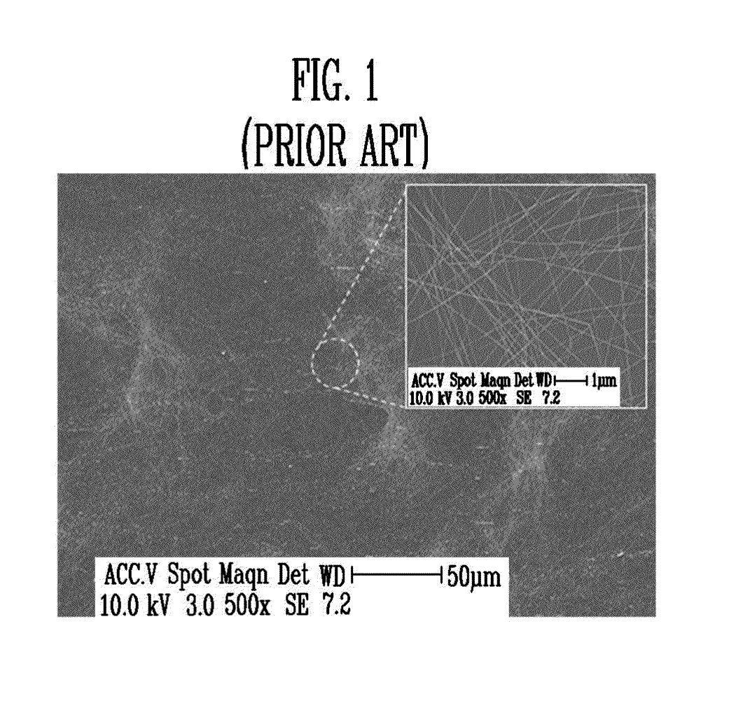

### DETAILED DESCRIPTION

Hereinafter, the most preferable embodiment of the present invention will be described. In the drawings, the thicknesses and the intervals of elements are exaggerated for convenience of illustration, and may be exaggerated compared to an actual physical thickness. In describing the present invention, a publicly known configuration irrelevant to the principal point of the present invention may be omitted. It should note that in giving reference numerals to elements of each drawing, like reference numerals refer to like elements even though like elements are shown in different drawings.

The present invention is a method of fabricating a nanowire and graphene-sheet hybrid structure including: operation S11 of fabricating a mixed solution of a nanowire material and a polymer material, and fabricating a nanowire line pattern by spraying the mixed solution on a grounded substrate by an electro-spinning method, operation S12 of dipping the substrate, on which the nanowire line pattern are formed, into a solution in which a graphene sheet is dispersed; and operation S13 of performing thermal processing so as to remove an interfacial surface between the nanowire lines in the nanowire line pattern.

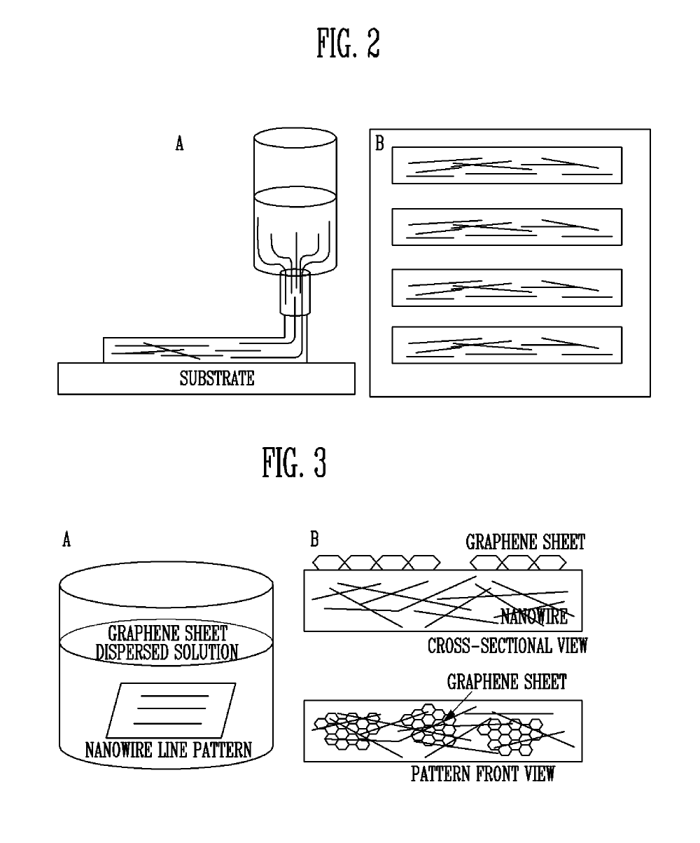

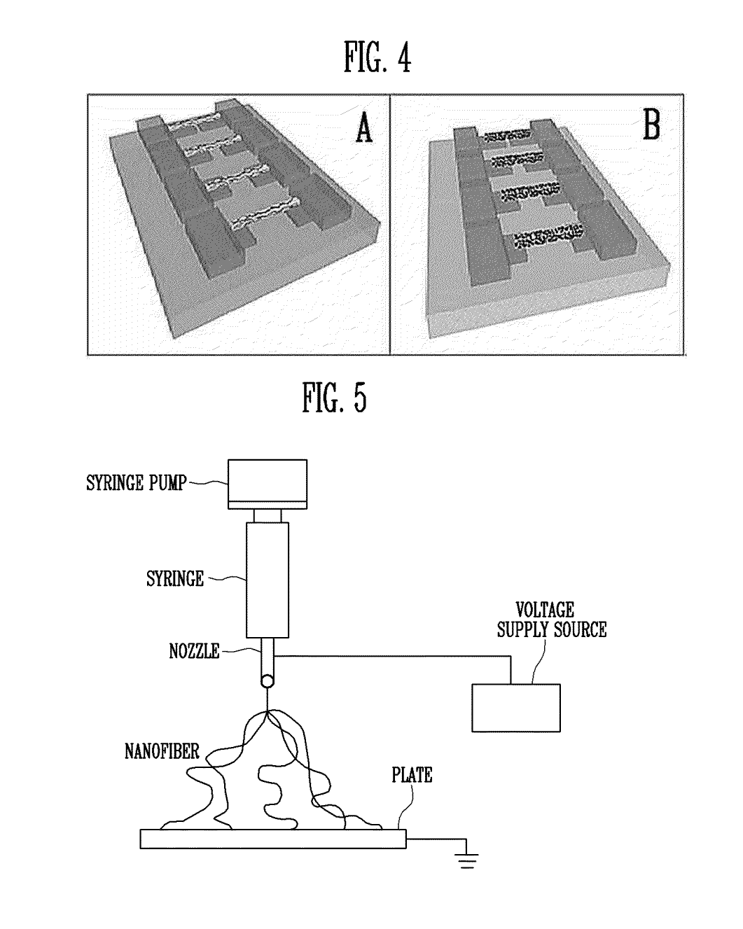

FIGS. 2 and 3 are mimetic diagrams illustrating a process of fabricating a nanowire and graphene-sheet hybrid structure according to an exemplary embodiment of the present invention.

Referring to FIG. 2, in operation S11 of fabricating the nanowire line pattern in the method of fabricating the nanowire and graphene-sheet hybrid structure, a solution, in which a nanowire material and a polymer material having a specific viscosity value (for example, 10 to 50 cps) is mixed, is injected into a syringe, an electric field is applied between a nozzle connected to a distal end of the syringe and a conductive plate positioned under the nozzle, and when the applied electric field is larger than surface tension of the mixed solution, the mixed solution is discharged through the nozzle, to form the nanowire line pattern.

That is, as illustrated in FIGS. 2A and 2B, the nanowires are discharged through the nozzle and are discharged in a longitudinally aligned form in a vertical direction, in which an electric field is applied as illustrated in FIG. 2A, to be aligned in a longitudinal direction along a line pattern as illustrated in FIG. 2B. When a line width of the line pattern is adjusted to be small to have several tens of μm, an interval between the internal nanowires is decreased, so that a portion, at which the nanowires are crosslinked to each other, is increased.

Accordingly, the line pattern has a low sheet resistance value of about several Ω/□ enough to be used as a transparent electrode, so that even though a nanowire layer is adjusted to be thin to have several μm, the line pattern has low sheet resistance and improved light transmittance.

Further, the line pattern is formed on the entire substrate as illustrated in FIG. 2B, so that the nanowires may be uniformly distributed over a large area.

The electro-spinning method will be described in more detail. First, the solution, in which the polymer material having the specific viscosity value (10 to 50 cps) and the nanowire material are mixed, is inserted into the syringe of electro-spinning equipment as illustrated in FIG. 5. When the mixed solution is pushed so as to be discharged through a spray nozzle connected to the distal end of the syringe by applying a predetermined pressure by a syringe pump, a droplet in a small form is formed at a distal end of a needle of the syringe. When a voltage is applied to the needle of the syringe by a high-voltage power supply device, a nanofiber is formed in the solution at a point, at which surface tension tending to maintain the form of the droplet without a change becomes larger than the applied voltage value, and the fine fiber is dropped in a form of an inverted triangle and sprayed on a plate, so that a pattern having an irregular form, such as a tangled skein of thread, is generated. In this case, the droplet sprayed from the end of the nozzle is not scattered by the surface tension, and is sprayed and attached to the grounded plate at the same time by static electricity repulsion for the voltage applied to the needle of the syringe. The used nozzle may be manufactured by a metal material, and the syringe may push the mixed solution from the spray nozzle at a speed of 0.01 to 0.1 ml/h per hole.

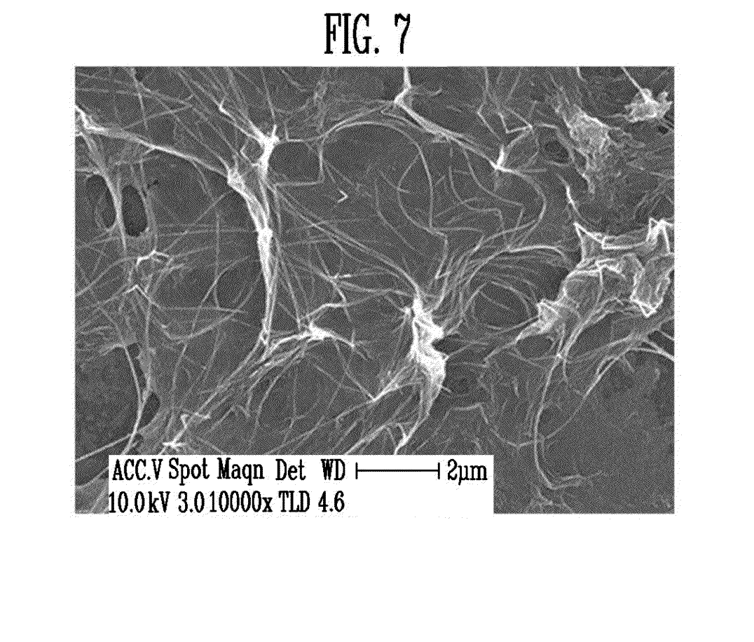

When the electro-spinning process is performed, it is possible to fabricate the pattern in the line form by using a part of pushing the droplet from the distal end of the nozzle in a straight line by adjusting the nozzle and the grounded plate to be close to have a distance of 2 to 4 mm like near field electro-spinning equipment illustrated in FIG. 6, which is called a near field electro-spinning method, and it is possible to adjust the line width of the line pattern to be several tens of μm or lower, which is narrow, by adjusting a movement speed in an X-Y-Z direction of the nozzle, the applied voltage, and a size of the nozzle, through which the solution is discharged, during the fabricating the pattern.

In the present invention, the applied voltage may have a value of 1 to 1.5 kV, the size of the nozzle may have a small diameter of several tens of μm or lower, and the distance between the surface of the substrate and the nozzle may have a value between 3 to 5 mm.

Here, the nanowire material may include one or more selected from the group consisting of metal-based Ag, Cu, Au, Pt, Mo, W, Ni , and Cr, and the polymer material may include one or more selected from the group consisting of polyvinyl alcohol (PVA), polyurethane (PU), polyimide (PI), polyethylene oxide (PEO), polyvinyl pyrrolidine (PVP), polystyrene (PS), and polyacrylonitrile (PAN).

The nanowire material is prepared as a dispersed solution by evenly dispersing the nanowire material within a solvent so as to have a ratio of 0.1 to 5 w % for preparation, and the polymer material is prepared as a mixed solution by melting the polymer material in a solvent so that the solution has viscosity of 10 to 50 cps. In this case, a ratio of the polymer material and the solvent may be 1 to 20 w %.

Further, the nanowire dispersion solution and the polymer solution may be prepared as the mixed solution by mixing the nanowire dispersion solution and the polymer solution within a range of 1:1 to 3:1.

Further, the line width in the nanowire line pattern may be several μm, and more preferably 10 to 90 μm.

Referring to FIG. 3, in operation S12 of dipping the nanowire line pattern in the solution in which the graphene sheet is dispersed, the nanowire line pattern is dipped in the dispersion solution in which the graphene sheet having a thickness of several to several tens of μm is evenly dispersed as illustrated in FIG. 3A, and a hybrid structure in which the graphene sheet covers the surfaces of the nanowires is fabricated as illustrated in FIG. 3B.

In this case, a time for dipping the nanowire line pattern in the dispersion solution is a time enough for the graphene sheet sufficiently to cover the surfaces of the nanowires, and may be 2 hours or more.

The dispersion solution in which the graphene sheet is dispersed may be prepared by a method below. First, natural graphite is oxidization treated with strong acid to disperse or exfoliate the natural graphite to graphene oxide (GO). Next, reduced graphene oxide (rGO) is obtained by reducing the GO through a thermal treatment. Subsequently, the rGO is dispersed in a dimethylformamide (DMF) organic solvent so that a ratio of the rGO and the organic solvent, such as DMF, is 0.1 w % to 0.5 w %, to prepare the graphene sheet dispersed solution.

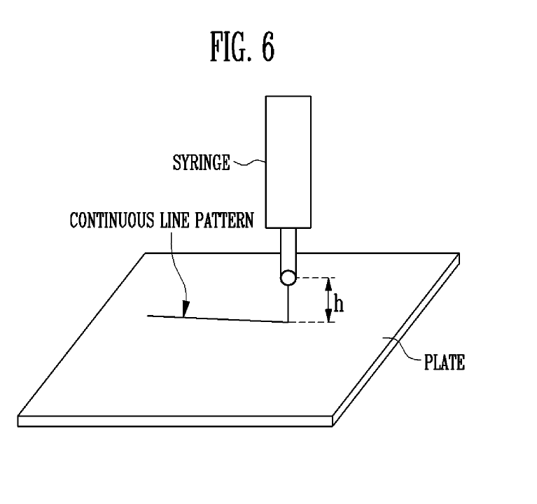

Referring to FIG. 4, in operation S13 of performing the thermal treatment for removing the interfacial surface between the nanowires, the interfacial surface, in which the two nanowires cross each other, is melted while the nanowires are melted as illustrated in FIG. 4B by putting the hybrid structure of FIG. 4A fabricated in the dipping operation into an electrical furnace and performing the thermal treatment at a specific temperature, so that the nanowires are connected.

In this case, the thermal treatment may be performed at the specific temperature of 70 to 90° C. for 5 to 20 minutes, but is not limited thereto, and the temperature may be appropriately selected by those skilled in the art.

In this case, the graphene sheet attached onto upper portions of the nanowires covers the surfaces of the nanowires to prevent oxidation of the nanowire due to a contact of the surfaces of the nanowires and oxygen in the air, thereby preventing a conductive property of the nanowires from deteriorating due to the oxidation.

Hereinafter, the present invention will be described in detail based on an example, but the present invention is not limited to the example.

### Example 1

Step 1. Prepare a mixed solution of silver (Ag) nanowires and a material

1. First, a dispersion solution is prepared by evenly dispersing silver nanowires in a solvent so as to have a ratio of 1 w %.

2. A mixed solution is prepared by melting polyvinyl alcohol in ultrapure water so that viscosity of the solution has a value of 5 to 30 cps. In this case, polyvinyl alcohol and ultrapure water are adjusted so that a ratio of the polymer material and the ultrapure water solvent is about 10 w % by evenly mixing 100 mg of polyvinyl alcohol and 100 ml of ultrapure water.

3. A mixed solution is prepared by mixing the prepared silver nanowire dispersed solution and the polymer solution so that a volume ratio of the prepared silver nanowire dispersed solution and the polymer solution is 2:1.

Step 2. Fabricate an alignment pattern in which the silver nanowires are continuously connected

1. The prepared mixed solution of the silver nanowire dispersed solution and the polymer solution mixed solution is inserted into a syringe, and a nozzle having a diameter of 50 μm is connected to a distal end of the syringe.

2. The syringe is connected to a syringe pump (flow meter), and a pressure is applied so as to push the solution inside the syringe at a speed of 0.01 ml/h.

3. An electric wire for applying a voltage to a lower plate on which the nozzle and the substrate are laid is connected.

4. The substrate is laid on the plate. In this case, the used substrate employs a circuit substrate, in which two metal electrodes are repeatedly fabricated, in order to evaluate an electrical characteristic of the fabricated pattern.

5. The type of substrate used in the present example may include a flexible substrate, such as plastic, a substrate in which silicon dioxide is thinly deposited on silicon, glass, and the like.

6. The nozzle is taken down so that a distance between a surface of the substrate and the nozzle is 4 mm to adjust the nozzle and the substrate to be close.

7. A high voltage having a value of 1.25 kV is applied between the nozzle and the plate.

8. A line pattern is fabricated so that the solution discharged from the nozzle has a continuous line form on the substrate by appropriately adjusting a movement direction and a movement speed of the plate movable in the X-Y-Z direction.

Step 3. Fabricate a hybrid structure in which the silver nanowires and a graphene sheet is mixed

1. The fabricated nanowire alignment pattern is dipped in the dispersion solution, in which the graphene sheet having a size of several tens of μm is evenly dispersed, to be maintained for 2 hours or more.

2. The graphene solution component attached to the surface of the substrate is clearly removed by taking out the substrate with a tweezer, dipping the substrate in a cleansing solution for an experiment, and lightly shaking the substrate.

3. Moisture of the surface is dried and removed by laying the substrate on a hot-plate and performing a thermal treatment on the substrate at 80° C. for 10 minutes.

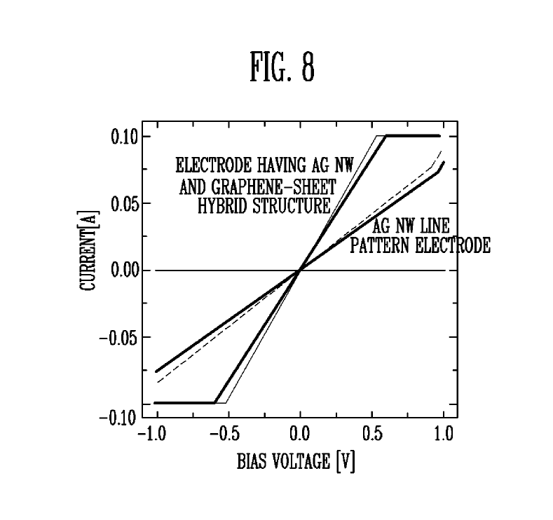

The nanowire and graphene-sheet hybrid structure fabricated through the process indicates the graphene sheet attached to surfaces of the silver nanowires as illustrated in FIG. 7.

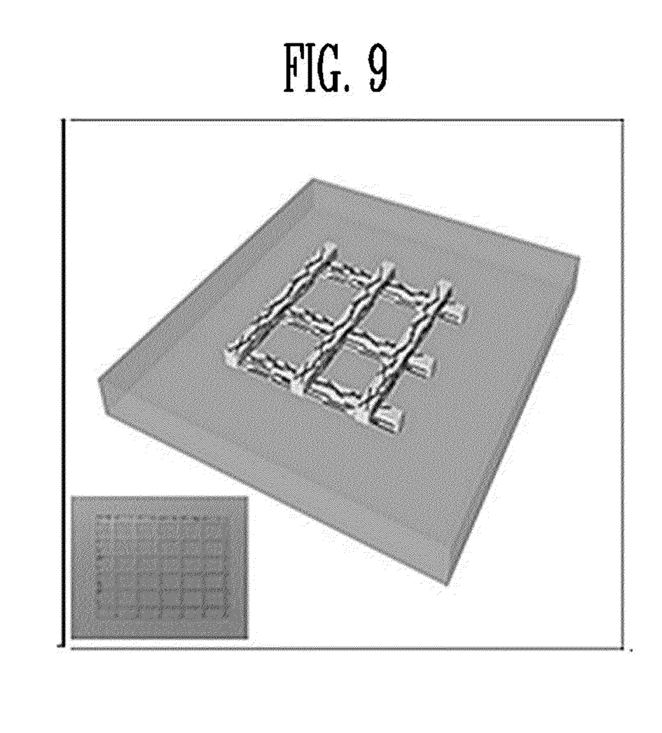

It can be seen that when a voltage is applied to the silver nanowire line pattern electrode fabricated in step 2 of the example, as the applied voltage is increased, a current value is continuously increased as indicated with a blue color in FIG. 8. Accordingly, it can be seen that the nanowires configuring the alignment pattern fabricated by the electro-spinning method is completely cross-linked, so that the current value is increased in proportion to the applied voltage.

It can be seen that when a voltage is applied to the patterned electrode having the silver nanowire and graphene-sheet hybrid structure fabricated in step 3 of the example is applied, a current value is further increased than the current value of the pattern formed of only the nanowires. Accordingly, the graphene sheet covers the surfaces of the nanowires to exhibit an effect of preventing oxidation of the nanowires during the thermal treatment process, and thus preventing a conductive property from deteriorating due to the oxidation of the nanowires.

FIG. 9 is a structure of a transparent electrode having the nanowire and graphene-sheet hybrid structure fabricated as described above. The picture of FIG. 9 is a picture of a transparent electrode having a mesh form including the nanowire and graphene-sheet hybrid structure actually fabricated through the present exemplary embodiment.

As described above, the embodiment has been disclosed in the drawings and the specification. The specific terms used herein are for purposes of illustration, and do not limit the scope of the present invention defined in the claims. Accordingly, those skilled in the art will appreciate that various modifications and another equivalent example may be made without departing from the scope and spirit of the present disclosure. Therefore, the sole technical protection scope of the present invention will be defined by the technical spirit of the accompanying claims.

What is claimed is:

1. A method of fabricating a nanowire and graphene- sheet hybrid structure, comprising:
preparing a mixed solution of a nanowire material and a polymer material;
forming a nanowire line pattern by spraying the mixed solution to a grounded substrate by an electro-spinning method;
dipping the substrate, on which the nanowire line pattern is formed, in a graphene sheet dispersed solution; and
performing a thermal treatment so as to remove an interfacial surface between the nanowire line patterns.

2. The method of claim 1, wherein the nanowire material is any one of Ag, Cu, Au, Pt, Mo, W, Ni, and Cr.

3. The method of claim 1, wherein the polymer material includes one or more selected from the group consisting of polyvinyl alcohol (PVA), polyurethane (PU), polyimide (PI), polyethylene oxide (PEO), polyvinyl pyrrolidine (PVP), polystyrene (PS), and polyacrylonitrile (PAN).

4. The method of claim 1, wherein a line width in the nanowire line pattern is 10 to 90 μm.

5. The method of claim 1, wherein the preparing of the mixed solution includes:
preparing a nanowire dispersed solution by dispersing nanowires in a solvent at a ratio of 0.1 to 5 w %;
preparing a polymer mixed solution having viscosity of 10 to 50 cps by melting the polymer material in a solvent; and
preparing the mixed solution by mixing the nanowire dispersed solution and the polymer mixed solution by a ratio of 2:1.

6. The method of claim 1, wherein the forming of the nanowire line pattern includes:
injecting the mixed solution into a syringe;
adjusting a distance between a nozzle and a plate to be 3 to 5 mm;
applying a high voltage of 1 to 1.5 kV between the nozzle and the plate; and
forming the nanowire line pattern by spraying the mixed solution through the nozzle at a speed of 0.05 to 0.1 ml/hour.

7. The method of claim 1, wherein the performing of the thermal treatment is performed at a temperature of 70 to 90° C. for 5 to 20 minutes.

8. The method of claim 1, wherein the nanowire and graphene-sheet hybrid structure has a mesh form.

9. A transparent electrode employing the nanowire and graphene-sheet hybrid structure fabricated by the method of claim 1.

10. A nanowire and graphene-sheet hybrid structure, comprising:
a nanowire mesh pattern having a mesh shape; and
a graphene-sheet formed on the nanowire mesh pattern,
wherein the nanowire mesh pattern includes nanowire line patterns coupled to each other without forming an interfacial surface therebetween.
